(19) United States
(12) Patent Application Publication
(10) Pub. No.: US 2007/0091480 A1
(43) Pub. Date: Apr. 26, 2007

(54) Convex bicycle mirror

(76) Inventor: Bryan Paul Varnes, Racine, WI (US)

Correspondence Address: BRYAN P. VARNES, 6457 WEMBLY LANE, RACINE, WI, 53406, US

(21) Appl. No.: 11/258,538

(22) Filed: Oct. 26, 2005

(51) Int. Cl. G02B 5/08

(52) U.S. Cl. 359/842; 359/871

(57) ABSTRACT

Adjustable, multi-directional viewing, convex-shaped bicycle mirrors mounted as one assembly to the fork, handle bars or frame of a bicycle, reflecting in the forward and backward direction of the cyclist. When a cyclist is in the crouched riding position with his face pointed toward the ground for less wind resistance, the mirrors can be optically canvassed simultaneously, surveying in the forward direction for objects being approached and in the rear direction for objects approaching the cyclist. When attached to the bicycle to be closer to the bicyclist's face while he is riding in the standing position, the bicyclist can survey the forward preceding extent and/or backside approaching objects in the mirror while also negotiating diminutive objects upcoming on the ground.

### FIELD OF THE INVENTION

This invention pertains to the safety of competitive-style bicycle riders who enjoy increased riding speeds over leisurely bike rides.

### BACKGROUND OF THE INVENTION

Most patented bicycle mirrors are flat in design, attach to the bicycle's handle bars and can only be viewed to see approaching objects when riding in the upright position. The current mirror designs that attach to the bicycle and/or cyclist separately view either objects being approached or objects approaching. These mirrors are limited in their ability to provide safety for the cyclists mentioned above, particularly not when they are riding in the crouched or standing position.

One current patent, U.S. Pat. No. 4,326,774 (Beigl), addresses this problem with a convex mirror attached to the fork of the bicycle but reflecting in the forward direction only. It does not reflect any backside approaching objects. The cyclist would still need to break from the crouched position, turning their body and head to look behind them, to view potentially dangerous approaching objects. While raising to the upright position and then looking behind himself, the cyclist loses focus on what may also be approaching or what is being approached, thereby adding a possible danger to the cyclist. This also adds wind resistance to the cyclist, slowing him down.

Another patent, U.S. Pat. No. 4,679,916 (Roller), addresses the problem of viewing the forward direction when the rider is in the crouched position. This mirror is attached directly to the cyclist helmet. While attached to the helmet, the mirror is prominently within view of the cyclist's peripheral vision. This can create a blind spot to the cyclist or cause an illusion of the cyclist approaching objects or objects approaching from behind which do not exist. This illusion could cause the cyclist to feel unsafe during the bike ride.

Another patent, U.S. Pat. No. 4,375,316 (Le Vantine), is an optical viewing device that mounts to the handlebars and provides the cyclist with a forward looking view when the cyclist has his head facing in the downward direction. This device works when the surface being viewed by the cyclist receives a reflection from a first reflecting surface. This combination lends itself to be restrictive to the cyclist while riding. The cyclist will only be able to view the approaching objects when his head is in one location. This can be a distraction to the cyclist's riding when he must constantly try to position his head in one location to be able to view with the device. This limits the cyclist to a set position when riding and can cause added stress to his muscles.

The advantages achieved over the prior art with the proposed convex-shaped mirror that allows viewing in two directions are increased crouched-position riding for achieving less wind resistance, increased bike speed, and less body fatigue because of less wind resistance and head movement; improved safety when approaching stationary objects, intersections or with approaching objects; and being able to safely viewing your surroundings while maneuvering the bicycle around small objects on the ground. The mirror's convex shape, ease in adjustment and its ability to be viewed from different angles also make it easy to use.

### SUMMARY OF THE INVENTION

A mirror assembly of two convex-shaped mirrors is mounted to the fork, handle bars or frame of a bicycle, reflecting in the forward and/or behind direction of the rider. Each aforementioned mirror is multi-adjustable along its viewing axis for the best viewing requirement for the individual cyclist. The pronounced convex shape is comfortably viewed for increased safety for the cyclist from various riding positions. The forward or behind reflecting mirror can be removed from the stationary holder depending on the requirement of the cyclist.

The mirror assembly is viewed from above, along the top by the cyclist's line of sight, to canvass the angle of reflection for an infinite distance forward and behind to survey both directions and detect any potential situations that may be detrimental to the rider.

Each mirror is individually adjustable along its axis of the angle of reflection for the comfort of the cyclist line of sight. Adjustments for each mirror are to a manufactured predetermined angle.

The mirror assembly is attached to an adjustable rigid bracket assembly which is mounted to a rigid positioned bracket conjoined to the standard two wheel bicycle. The mirror assembly is moved forward and away from the cyclist or back toward the cyclist to accommodate the cyclist's line of sight.

### DESCRIPTION OF THE DRAWINGS

FIG. 1 is the top view of the bicyclist shown in the crouched position with his face pointing perpendicular toward the ground.

FIG. 2 is the side view of the bicyclist shown in the crouched position with his face pointing perpendicular toward the ground.

FIG. 3 is the top view of the bicyclist shown in a standing type position with his head slightly angled down viewing the total area perspective in front of him.

FIG. 4 is the side view of the bicyclist shown in a standing type position with his head slightly angled down viewing the total area perspective in front of him.

FIG. 5 is the tope view of the adjustable convex mirror assembly mounted to the bicycle.

FIG. 6 is the side view of the adjustable convex mirror assembly mounted to the bicycle.

### DETAILED DESCRIPTION OF PREFERRED EMBODIMENTS

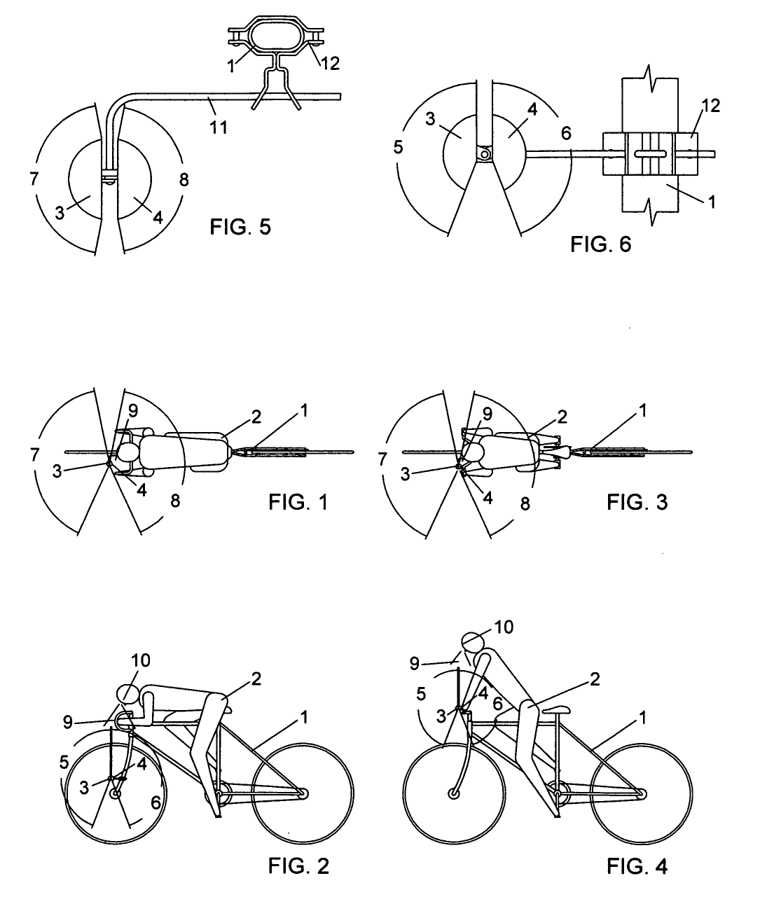

Shown in FIG. 1 is the top view of the standard type two-wheel bicycle 1 being ridden by the cyclist 2 with his body perpendicular to the bicycle and his face 10 pointed toward the ground in the crouched position. The cyclist 1, using his line of sight 9, to view the angle of reflection for an infinite distance 7 and 8 of the assembled convex mirrors 3 and 4 while riding.

Shown in FIG. 2 is the side view of the standard type two-wheel bicycle 1 being ridden by the cyclist 2 with his spine in a horizontal position and his face 10 pointed toward the ground in the crouched position. The cyclist 1 uses his line of sight 9, to view the angle of reflection for an infinite distance 5 and 6 of the assembled convex mirrors 3 and 4 while riding.

Shown in FIG. 3 is the top view of the standard type two-wheel bicycle 1 being ridden by the cyclist 2 with his body perpendicular to the bicycle, his buttocks removed from the seat and his spine in an upright position leaning forward toward the front of the bicycle, the majority of his weight balanced on the pedals. His face 10 is pointed downward in the standing position when not raising his head up. The cyclist 1 uses his line of sight 9 to view the angle of reflection for an infinite distance 7 and 8 of the assembled convex mirrors 3 and 4 while riding.

Shown in FIG. 4 is the side view of the standard type two-wheel bicycle 1 being ridden by the cyclist 2 with his buttocks removed from the seat and his spine in an upright position leaning forward toward the front of the bicycle, the majority of his weight balanced on the pedals. His face 10 is pointed downward in the standing position when not raising his head up. The cyclist 1 uses his line of sight 9 to view the angle of reflection for an infinite distance 5 and 6 of the assembled convex mirrors 3 and 4 while riding.

Shown in FIG. 5 is the close-up of the top view of an assembled pair of adjustable convex shaped mirrors 3 and 4 reflecting in opposite directions of each other. The angle of reflection of mirrors 3 and 4 for an infinite distance 7 and 8 are shown. The mirrors 3 and 4 are made of glass or a lightweight reflective material adhered to a lightweight durable background. The aforementioned assembly is adjustable independently along the axis of the angle of reflection 7 and 8 to a manufactured predetermined angle by manually ratcheting by hand into the line of sight 9 of cyclist 2 for the comfort of the rider. Mirrors 3 and 4 are shown securely attached to the lightweight durable bracket assembly 11. The assembly 11 is securely fastened to the bicycle 1 with a lightweight durable bracket 12. The mirrors 3 and 4 are simultaneously adjusted by hand, front to back, into the line of sight 9 of cyclist 2 for the comfort of the rider using the adjustable bracket 11 and bracket 12 and secured in place.

Shown in FIG. 6 is the close up of the top view of an assembled pair of adjustable convex shaped mirrors 3 and 4 reflecting in opposite directions of each other. The angle of reflection of mirrors 3 and 4 for an infinite distance 5 and 6 are shown. The mirrors 3 and 4 are made of glass or a lightweight reflective material adhered to a lightweight durable background. The aforementioned assembly is adjustable independently along the axis of the angle of reflection 5 and 6 to a manufactured predetermined angle by manually ratcheting by hand into the line of sight 9 of cyclist 2 for the comfort of the rider. The assembly is shown securely attached to the lightweight durable bracket assembly 11. The assembly 11 is securely fastened to the bicycle 1 with a lightweight durable bracket 12. The mirrors 3 and 4 are simultaneously adjusted by hand front to back into the line of sight 9 of cyclist 2 for the comfort of the rider with the adjustable bracket 11 and bracket 12 and secured in place.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. Cancelled.

2. An adjustable optical viewing device comprising:
a first mirrored surface adjustably positioned to reflect light received substantially over a first range of directions having a first rear wall pivotally secured at a first end of a bracket assembly;
a second mirrored surface adjustably positioned to reflect light received substantially over a second range of directions having a second rear wall pivotally secured to the first end of the bracket assembly, the second rear wall being spaced-apart horizontally from the first rear wall and oriented to substantially face the first rear wall; and
the bracket assembly removably mounted to a bicycle at a second end.

3. The device of claim 1 wherein at least one mirrored surface is convex.

4. The device of claim 2 wherein both mirrored surfaces are convex.

5. The device of claim 1 wherein the bicycle has a front and a rear and the first mirrored surface is adjustably positioned to face substantially towards the front of the bicycle and the second mirrored surface is adjustably positioned to face substantially towards the rear of the bicycle, whereby an individual riding the bicycle can see objects approaching the front of the bicycle by looking into the first mirrored surface and objects approaching the rear of the bicycle by looking into the second mirrored surface.

6. The device of claim 1 wherein the first range is substantially 180°.

7. The device of claim 1 wherein the second range is substantially 180°.

8. The device of claim 1 wherein the bracket assembly includes an assembly rod and a bracket, the rod having first and second ends, mirrored surfaces being pivotally secured to the first end of the assembly rod and the second end of the assembly rod being slidably and rotatably secured to the bracket, whereby the mirrored surfaces can be adjusted radially along an axis of the first end, radially along an axis of the second end, and longitudinally along the axis of the second end.
